(19) United States
(12) Patent Application Publication
(10) Pub. No.: US 2008/0197553 A1
(43) Pub. Date: Aug. 21, 2008

(54) POWER CLAMP HAVING DIMENSION DETERMINATION ASSEMBLY

(76) Inventors: Erick William Rudaitis, Sterling Heights, MI (US); Jeffrey Gerald Kozlowski, Clinton Township, MI (US); Jeffrey Thomas Taylor, Warren, MI (US); Alan J. Blohm, Sterling Heights, MI (US)

Correspondence Address: BOSE MCKINNEY & EVANS LLP;2700 FIRST INDIANA PLAZA, 135 NORTH PENNSYLVANIA, INDIANAPOLIS, IN, 46204, US

(21) Appl. No.: 11/676,345

(22) Filed: Feb. 19, 2007

(51) Int. Cl. B25B 5/06; G12B 13/00

(52) U.S. Cl. 269/90; 29/559; 73/1.01

(57) ABSTRACT

A power clamp including a dimension determination assembly. The dimension determination assembly can determine a dimension of single or multiple clamped parts. If the determined dimension of the clamped workpiece, part or parts is incorrect, a signal is generated to indicate the determined dimension is outside of an acceptable range.

### FIELD OF THE INVENTION

The present invention relates to a clamp apparatus which converts a linear motion of a cylinder into a rotary motion of a clamping arm. In particular, the present invention relates to a clamp apparatus which can determine the presence of or a dimension of a clamped workpiece, which can include either single parts or multiple parts.

### BACKGROUND OF THE INVENTION

Power clamps can be used to clamp components, parts, or workpieces secured together in the manufacture of products. For instance, power clamps are used to hold one or more parts together for a welding operation in the manufacture of automobiles.

Power clamps can be actuated by the application of a pressurized fluid, such as air, other gases, or a hydraulic fluid. The power clamp, also known as a clamp cylinder apparatus, can include a piston rod coupled to a piston which moves linearly in a reciprocal fashion within a housing. The movement of the piston in one direction causes an arm to rotate to a location to provide a clamping force. Movement of the piston in the opposite direction provides for removal of the arm from the article being clamped. One example of such a clamp apparatus is described in Published U.S. patent application entitled “Clamp Apparatus”, having the publication No. 2004/0041324 and having a filing date of Aug. 19, 2003 and U.S. patent application entitled “Power Clamp having Kinetic Energy Control”, having the Ser. No. 11/410,351, and having a filing date of Apr. 25, 2001, both of which are incorporated herein by reference in their entirety.

In an automated manufacturing facility, when clamping parts or pieces, it is desirable to determine a dimension of the parts. Often, if the clamped workpiece or part is too thick, the thickness can indicate too many parts are being clamped. Clamping too many pieces or not enough pieces can result in operation slow down and usually scrapping of the parts, both of which result in monetary losses.

### SUMMARY OF THE INVENTION

The present invention provides an apparatus capable of clamping a workpiece or part. The apparatus provides the additional capability of determining a workpiece dimension such as width, length, or height.

In accordance with one aspect of the present invention there is provided a clamp including an arm to clamp a workpiece in a clamp position. The clamp includes a toggle mechanism coupled to the arm, to move the arm to the clamp position, a catch, disposed adjacent to the toggle mechanism, to restrict movement of the arm when in the clamp position, and a sensor disposed adjacent to the catch, to provide a signal representative of a dimension of the workpiece when the arm is in the clamp position.

In accordance with another aspect of the present invention there is provided a method for clamping a workpiece and determining a dimension of the workpiece with an arm of power clamp including a catch to restrain the arm in a clamped position. The method includes the steps of providing a dimension determining assembly based on movement of the catch, moving the arm to a clamp position; determining a dimension of the workpiece based on the movement of the catch, and comparing the determined dimension of the workpiece to a predetermined dimension value.

In accordance with still another aspect of the present invention there is provided a method for calibrating a clamp apparatus to provide a dimension measurement of a workpiece being clamped. The method includes the steps of determining a first dimension of a workpiece, storing a signal representative of the first dimension, determining a second dimension of the workpiece, and storing a signal representative of the second dimension.

### BRIEF DESCRIPTION OF THE DRAWINGS

The above-mentioned and other advantages of the present invention and the manner of obtaining them will become more apparent and the invention itself will be better understood by reference to the following description of the embodiments of the invention taken in conjunction with the accompanying drawings, wherein:

FIG. 1 is a partial cutaway elevational view of a clamp apparatus including a dimension determination assembly of the present invention;

FIG. 2 is a partial schematic exploded view of components used in one embodiment of the present invention;

FIG. 3 is a partial cutaway elevational view of the clamp apparatus in the unclamped position;

FIG. 4 is a partial cutaway elevational view of the clamp apparatus in the clamped position;

FIG. 5 illustrates a sensor assembly adjacent a toggle mechanism of the clamp apparatus;

FIG. 6 illustrates a block diagram of the electronic components of the sensor assembly including a sensing circuit according to one embodiment of the present invention;

FIG. 7 is a schematic view of an Op-amp circuit according to one embodiment of the present invention;

FIG. 8 is a schematic view of an Op-amp circuit according to another embodiment of the present invention; and

FIG. 9 is a flow chart describing one embodiment of the calibration process of the dimension determining assembly of the current invention.

### DETAILED DESCRIPTION OF THE DRAWINGS

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

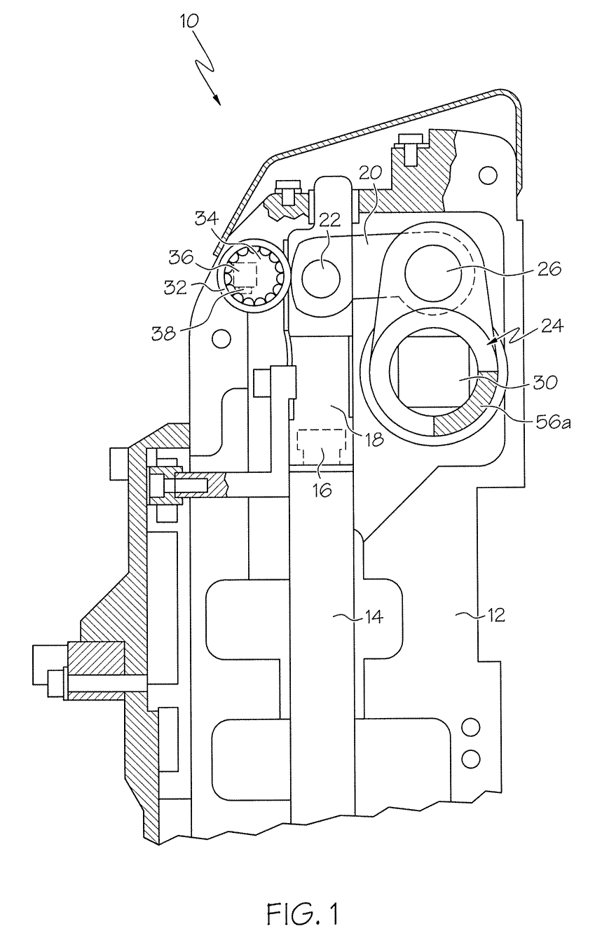

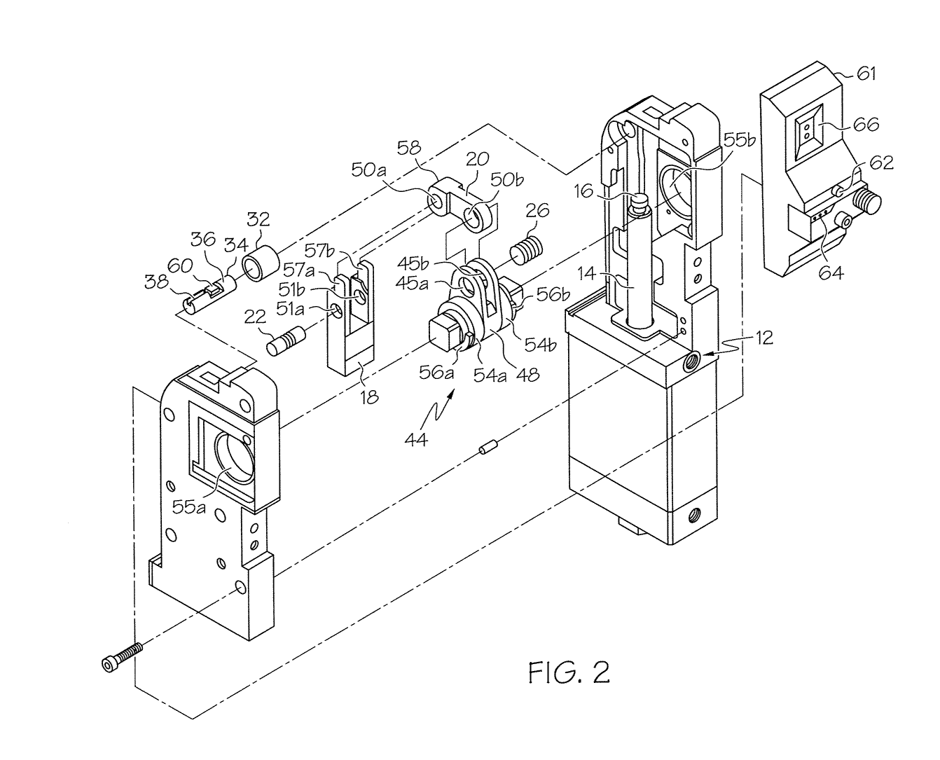

FIG. 1 illustrates a partial cutaway elevational view of the clamp apparatus 10 of the present invention including a dimension determination assembly. The determination assembly detects the thickness or other dimension of a workpiece which can include a part, or an assembly of parts, by indirectly determining the dimension of interest with a strain gauge. As used herein the term “workpiece” includes either a single part or multiple parts, such as an assembly of parts. The clamp apparatus 10 includes a body 12 which provides a housing for the various components either disposed within or coupled to the clamp apparatus 10. The body 12 houses a piston rod 14 coupled to a disk-shaped projection 16 (see also FIG. 2), which engages a knuckle block 18. A link plate 20 is coupled to the knuckle block 18 with a knuckle pin 22. The link plate 20 is also coupled by a link pin 26 to a toggle block mechanism 24. The toggle block mechanism 24 is also coupled to or can include a bearing section 30 which forms an arm attachment for coupling to a clamp arm (not shown).

The link plate 20, when in a clamp position, is disposed adjacent to a guide roller 32. The guide roller 32 includes an annular access to receive a pin member 34. The pin member includes a strain gauge cutout 36 and a strain gauge wire cutout 38.

The linear motion of the piston rod 14 rotates the bearing section 30 by way of the toggle block mechanism 24, as described in greater detail, hereinafter. The rotational movement of the bearing section 30 moves the clamp arm (not shown) from an open position to a closed position and vise versa for clamping and unclamping a workpiece.

FIG. 2 is a partial schematic exploded view of components used in one embodiment of the current invention. Usual operation of the clamp apparatus includes injecting fluid, such as air, at a first location to cause the piston rod 14 to move in a first direction or upwardly (as illustrated) to begin the clamping operation. Once the clamping operation is complete the fluid is injected at a second location to move the piston rod in a second direction or downwardly (as illustrated). The piston rod 14, including the disk-shaped projection 16, connects to the bottom portion of knuckle block 18. The piston rod 14 moves the knuckle block 18 upwardly which moves the link plate 16 via the knuckle pin 22 about the link pin 26. The knuckle pin 22 is located in knuckle block holes 51(a) and 51(b) and through back-side link plate hole 50(a). The link plate 20 rotates the toggle block mechanism 24 via the link pin 26. The link pin 26 is located in support block holes 45(a) and 45(b) and through front-side link plate hole 50(b).

The support block 48 includes toggle mechanism circumferential sections 54(a) and 54(b) which are supported in bearing circumferential sections 55(a) and 55(b). The support block 48 includes arc-shaped projections 56(a) and 56(b) which limit the rotational movement of the toggle mechanism 24. The knuckle block 18 includes release projections 57(a) and 57(b) which can be used to knock down and release the knuckle block 18 from the clamp position. This technique is only used when the normal operation fails to move the piston rod 32 down.

The link plate 20 includes first and second sides. At one end of link plate 20, a link plate cam surface 58 contacts the guide roller 32 as the clamp apparatus approaches the clamp position. The contact between the link plate cam surface 58 and the guide roller 32 transfers a force to the pin member 34.

The contact force between the link plate cam surface 58 and guide roller 32 provides at least two results. First, the pin member 34 inside the guide roller 32 deflects causing a change in the resistance of a strain gauge 60, which is mounted inside the strain gauge cutout 36. One example of a strain gauge suitable for use in the present embodiment is as Omega SG-6/120-HLY41 strain gauge available from Omega Engineering, Inc. of Stamford, Conn. This change in resistance is detected by a sensing circuit which is described later herein. In addition, the contacting force of the link plate cam surface 58 moving over the guide roller 32 acts as a catch to hold the knuckle block 18 in the clamp position. The link plate cam surface 58 contacts the guide roller 32, thereby exerting a force on the guide roller. A frictional force between the cam surface 58 and the roller bearing 32 holds the knuckle block 18 in the clamp position.

A cover 61 is coupled to body 12 via a cover screw 62. A series of LED lights 64 are located on the front cover 61 to provide information to a user about the state of the clamp apparatus. A selector switch 66 is used to calibrate the clamp apparatus as will be described later.

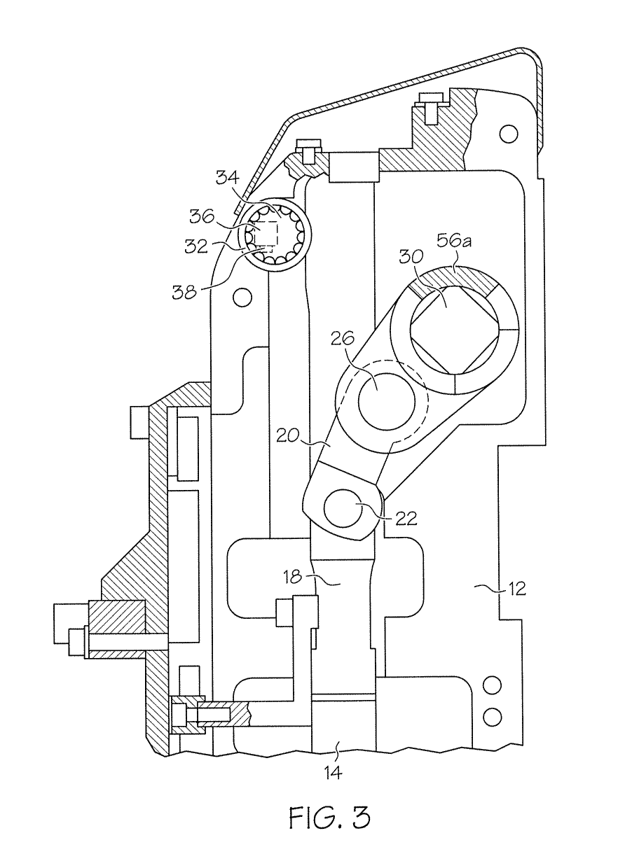

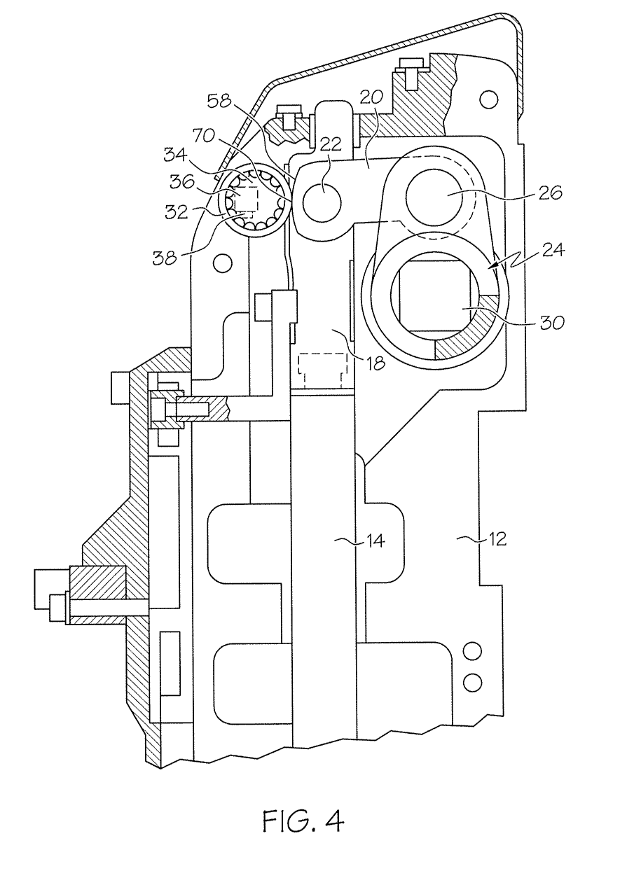

FIG. 3 is a partial cutaway elevational view of the clamp apparatus in the unclamped position. The piston rod 14 (connected to the disk-shaped projection 16 (not shown) and which is connected to knuckle block 18) is in the unclamped position. Fluid is injected in a bottom fitting (not shown) which causes the piston rod 14 to move upwardly as illustrated. As fluid is continually provided to a bottom fitting (not shown) of the clamp apparatus, the piston rod 14 continues to travel upwardly as further shown in FIG. 4. The clamp is designed such that when the clamp apparatus has clamped the workpiece, a highest point 70 of the link plate cam surface 58 contacts roller bearing 32. Due to frictional forces, this position is held as a catch to maintain the clamp in a clamped position until the unclamping operation begins.

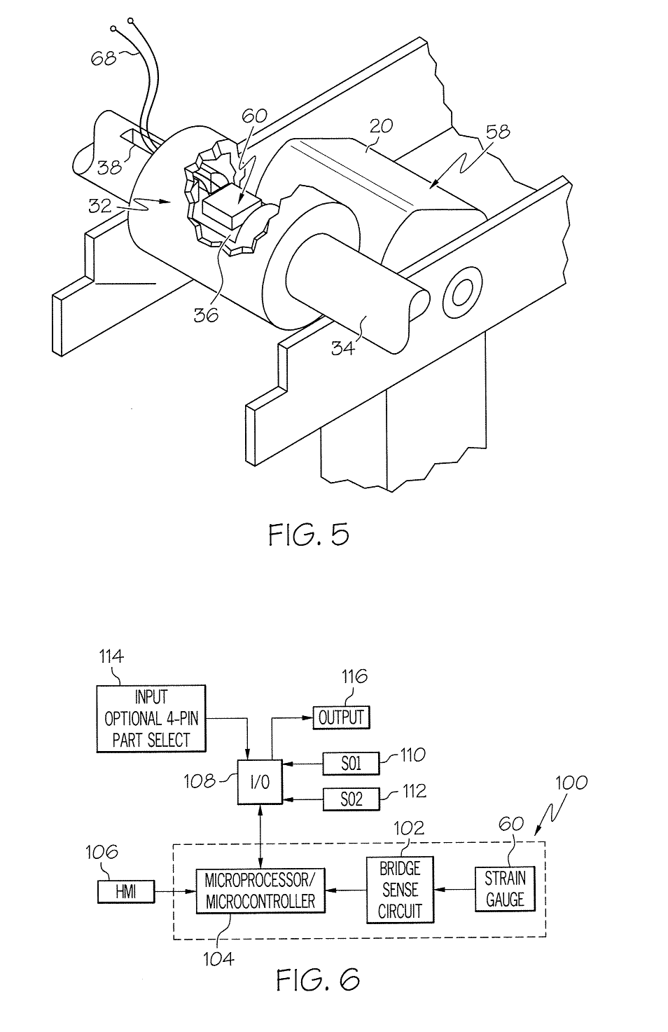

FIG. 5 is a cut away view of the guide roller 32 with link plate 20 spaced from the pin member 34. The link plate cam surface 58 is just beginning to contact the guide roller 32. The strain gauge 60 is shown at the strain gauge cutout 36. Strain gauge wires 68 within the guide roller 32 are disposed within strain gauge wire cutout 38 and are coupled to a sensing circuit described later herein.

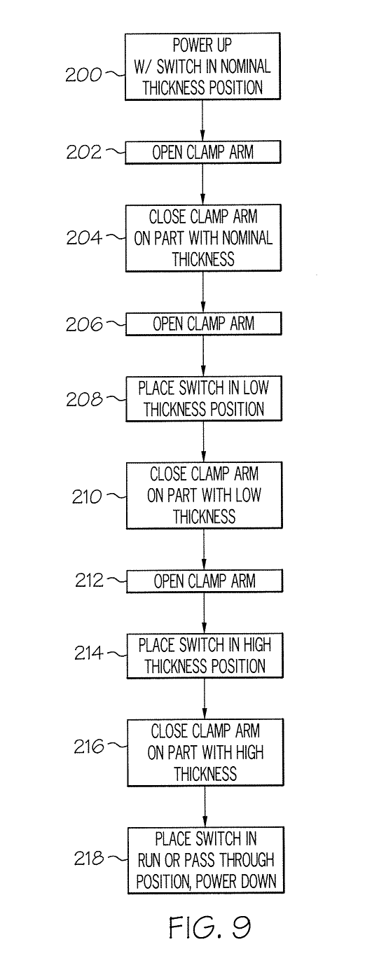

FIG. 6 illustrates a block diagram of the electronic components of the sensor assembly including a sensing circuit 100 according to one embodiment of the present invention to sense a change in resistance in the strain gauge 60. The strain gauge 60 is connected to an Op-amp circuit 102 and which is connected to an Analog/Digital converter (A/D) port of a microprocessor/microcontroller (MICRO) 104. If a microprocessor is used and the microprocessor does not include an A/D converter, an A/D Integrated Circuit (IC) of the variety well known in the art may be used in conjunction with the microprocessor. Alternatively, an analog comparator circuit may be used in conjunction with the Op-amp circuit or a combination of strain gauge, Op-amp, A/D and a digital comparator to achieve the same result. Such alternatives are known to those skilled in the art. For instance, the use of a MICRO provides programmability and memory as further illustrated in FIG. 9. The combination of strain gauge 60, Op-amp circuit 102, and the MICRO 104 forms the sensing circuit 100. Also, coupled to the MICRO is the Human Machine Interface (HMI) 106 and additionally Input/Output (I/O) interface 108 for inputs 110 and 112 received from the selector switch 66 (See FIG. 2), input from an optional workpiece select switch 114, and outputs 116 to the LED lights 64. The output of the op-amp circuit 102 is fed to an A/D port of the MICRO 104. The MICRO 104 interprets the voltage level from the op-amp circuit 102 as an indicator of the amount of movement in the guide roller 36.

The human machine interface 106 can include a programmable logic controller; a desktop, portable or laptop computer; or any other computing device capable of providing instructions or control for the clamp apparatus. For instance, the workpiece select switch 114 is adapted to receive a signal or input from the interface 106, or from other suitable devices coupled directly to the switch 114. The received input at the switch 114 programs the clamp apparatus to recognize a particular workpiece. For instance, the apparatus can be pre-programmed to recognize between four different workpieces. To begin a run of a particular workpiece, the select switch 114 can be switched to recognize the first of the four different workpieces. Once switched, the clamp apparatus operates to clamp workpieces of the first kind. After the run of the first kind of workpiece has been completed, the select switch 114 can be switched to recognize a second of the four different workpieces. In this way, the apparatus does not have to be taught a new dimension each time a product line or workstation is converted from one workpiece to another, but can be initially programmed to recognize one of many different kinds of workpieces.

Selection of different workpieces can be achieved in binary by assigning a “0, 0” to the first kind of workpiece, “0, 1” to the second kind of workpiece, “1, 0” to the third kind of workpiece, and a “1, 1” to the fourth kind of workpiece. A controller sending these signals to the clamp causes the clamp to recognize the selected workpiece. While the present description refers to programming the clamp apparatus to recognize four different kinds of workpieces, it is within the scope of the present invention to recognize one or more workpieces and is not limited to four.

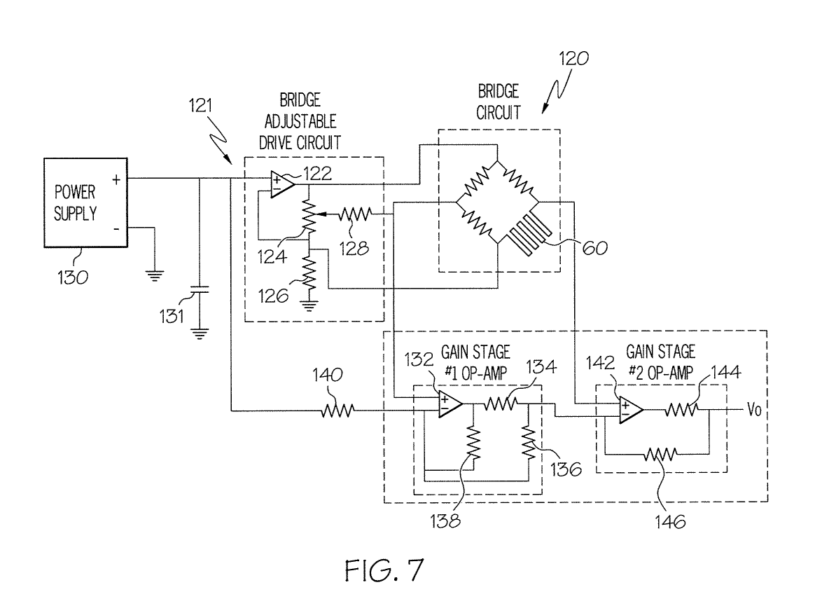

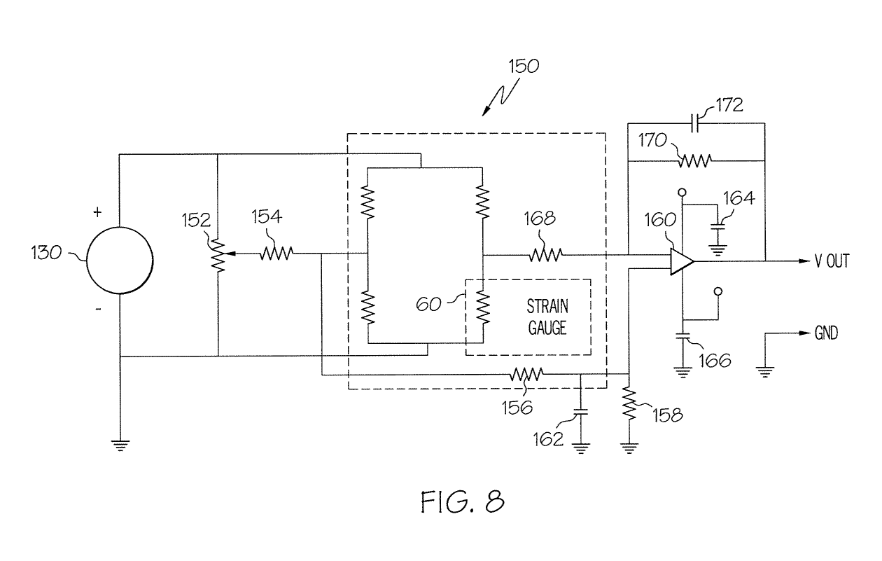

FIG. 7 is a schematic view of the Op-amp circuit 102 according to one embodiment of the present invention. A bridge circuit 120 receives a signal from the strain gauge 60. The bridge circuit 120 is excited with a bridge circuit Op-amp circuit 121 having an adjustable gain which includes an Op-amp 122, a variable resistor 124 and a network of voltage dividing resistors 126 and 128. The bridge circuit Op-amp 122 is powered by power supply 130 having an output coupled thereto and filtered by capacitor 131. Use of the bridge circuit Op-amp with adjustable gain circuit immunizes the bridge circuit 120 from voltage variation seen in power supplies due to temperature variations, which is well known in the art, and thereby provides a reduced cost power supply 130. The output of the Op-amp circuit is fed to the MICRO 104 or the equivalent thereof as described above. It has been found that a gain of 999 pursuant to the formula Vₒᵤₜ=999(Vₜ−V₋)+2.5 provides a signal of sufficient amplitude. Other gains are within the scope of these present inventions as long as the signal includes an amplitude sufficient for recognition by the MICRO 104.

FIG. 8 is a schematic view of an alternative embodiment of the Op-amp circuit 102. The power supply 130 is used to excite a bridge circuit 150. Voltage from one side of the bridge circuit 150 is adjusted by the user with the adjustable voltage divider circuit consisting of adjustable resistors 152 and resistors 154. The differential Op-amp provides an output voltage for the MICRO 104 or equivalent circuit thereof.

FIG. 9 illustrates a calibration process for dimension determination. The calibration process is used for indirectly determining a dimension, such as a thickness of a workpiece. While a numerical value of thickness is not provided, a signal having a value indicating a dimensional range is provided. This value is sufficient to determine whether the clamp is clamping the correct predetermined workpiece, part or number of parts or the presence or absence of one or more workpieces or parts.

The clamp apparatus can require an initial calibration and can also lose calibration and therefore require recalibration. Wear from use can require a recalibration. The calibration process or recalibration process begins in step 200 during a power up sequence with the selector switch 66 in a nominal thickness position. This step begins the process of teaching the apparatus to recognize whether a workpiece meets a predetermined size limitation. In step 202, the clamp arm is opened, if necessary, by providing fluid to the appropriate fitting. Once a workpiece, preselected to have a known nominal dimension, is placed within the clamp apparatus, at step 204, the clamp apparatus closes on the preselected workpiece. The dimension of the workpiece is determined indirectly by the sensing circuit as being a function of the movement of the pin member 34. A signal is generated and stored in the MICRO 104. In step 206, the clamp arm is opened and the selector switch 66 is placed in a minimum acceptable dimension position (step 208). In step 210, the clamp apparatus closes on a workpiece, preselected to have a minimum acceptable dimension, and the dimension of the workpiece is determined via the sensing circuit as described above. A second signal indicative of the minimum dimension is stored. Steps 206, 208, and 210 are repeated for a maximum dimension workpiece, preselected to have a maximum acceptable dimension as shown in steps 212, 214, and 216. At the conclusion of the calibration process, in step 218, the operator places the selector switch 66 in the run position and powers down. Electronic representation of minimum, nominal and maximum dimensions, such as thickness proportional to the movement of the pin member 34 can be electronically stored for future comparison.

It is also possible to place the switch in a “pass-through” mode position. In this position, the part determination or part sensing capability of the apparatus is turned-off. The pass-through mode passes a part or workpiece through the clamp without the clamp providing sensing for the part or workpiece. This mode can be selected if the sensing capability of the clamp apparatus becomes inoperative or if the sensing capability is not required or desired.

The described embodiments can not only determine whether the size of the workpiece falls within the predetermined range, but can also detect for the mere presence or absence of a part. For instance, in one embodiment it is possible to teach the apparatus to recognize the presence of a part by closing the clamp on a minimum thickness part. This teaches the apparatus the minimum size. The apparatus is then closed on the maximum size part to teach it the maximum part allowed. In this situation, however, the nominal thickness part is not clamped by the clamp, but the maximum size part is clamped a second time and recorded as the nominal thickness. In this way, the clamp recognizes the presence or absence of a workpiece having one or more pieces. It is also within the scope of the present invention to have a clamp apparatus to detect only for the presence or absence of a workpiece but not to detect for a nominal workpiece. In this case, it is possible to clamp only the minimum and maximum part or just the minimum size part to achieve a value for storing in the clamp apparatus.

Once the clamp apparatus has been calibrated, the clamp apparatus is ready for operation. When the clamp apparatus is actuated to the closed position, the dimension of interest of the workpiece is indirectly determined by sensing the amount of movement in the pin member 34. The dimension of the workpiece is determined to be proportional to the movement, displacement or deflection of the roller 32 and/or pin member 34 and is represented as the signal output of the strain gauge 60. This signal, after amplification, is compared to the electronically stored minimum, nominal and maximum dimension values. If the measured thickness is outside of a range or an envelope defined by the electronically stored values of minimum and maximum thicknesses, the clamp apparatus ceases operation and a non-nominal workpiece thickness flag is set. Additionally, lights or other indicators customarily used in production environments can be used to indicate to the operator that the clamp apparatus has clamped a workpiece with a non-nominal thickness. The operator can then stop operation, manually remove the workpiece, and reset the non-nominal workpiece thickness flag. It is also within the scope of the present invention to generate a signal upon the detection of a workpiece having a non-nominal thickness or the absence of a workpiece. The signal could be sent to a programmable logic controller or other computing device to automatically stop the operation. Once the operator has cleared the clamp, the operator could send a signal to restart the clamping process.

While this invention has been described with specific embodiments thereof, alternatives, modifications and variations may be apparent to those skilled in the art. Accordingly, it is intended to embrace all such alternatives, modifications and variations that fall within the spirit and broad scope of the claims.

1. A clamp apparatus including a housing and an arm to clamp a workpiece in a clamp position, comprising:
a pin supported by the housing;
a roller supported by the pin, to restrict movement of the arm;
a toggle mechanism, coupled to the arm and disposed adjacent to the roller, to move the arm to the clamp position; and
a sensor disposed adjacent to the pin, wherein the sensor provides an output signal indicative of a force applied to at least one of the pin and the roller to provide a signal indirectly representative of a dimension of the workpiece when the arm is in the clamp position.

2. The apparatus of claim 1, wherein the roller includes a contact surface to contact the toggle mechanism, the contact surface being moved by the toggle mechanism when the arm is in the clamp position.

3. (canceled)

4. (canceled)

5. The apparatus of claim 2, wherein the sensor includes an output, to transmit the output signal, wherein a value of the output signal indicates a force applied to the contact surface by the toggle mechanism.

6. The apparatus of claim 5, further comprising a piston, coupled to the toggle mechanism, wherein the piston moves linearly to move the toggle mechanism.

7. The apparatus of claim 5, wherein the sensor comprise a strain gauge.

8. The apparatus of claim 5, wherein the sensor comprises a sensing circuit.

9. The apparatus of claim 8, wherein the sensing circuit includes a power supply.

10. The apparatus of claim 8, wherein the sensing circuit includes a balanced bridge.

11. The apparatus of claim 8, wherein the sensing circuit includes an output amplifier.

12. The apparatus of claim 8, wherein the sensing circuit comprises at least one of a microprocessor, a microcontroller, and a comparator circuit.

13. The apparatus of claim 10, wherein the balanced bridge comprises one of a quarter bridge circuit, a half bridge circuit, and a full bridge circuit.

14-26. (canceled)

27. The apparatus of claim 1, further comprising a microprocessor coupled to the sensor to receive from the sensor the output signal indirectly representative of a thickness of the workpiece.

28. The apparatus of claim 27, further comprising a workpiece select switch, coupled to the microprocessor, adapted to receive a signal indicative of one of a plurality of different workpieces to enable the apparatus to recognize a particular workpiece.

29. The apparatus of claim 1, wherein the toggle mechanism includes a cam surface, to contact the catch, the catch being moved upon contact with the cam surface.

30. The apparatus of claim 29, wherein the catch comprises a roller.

31. The apparatus of claim 29, wherein the catch comprises a pin.

32. The apparatus of claim 30, wherein the catch comprises a pin disposed within the roller.

33. The apparatus of claim 29, wherein the catch includes a contact surface to contact the cam surface and the sensor provides a signal representative of the movement of the catch.

34. The apparatus of claim 2, wherein the toggle mechanism includes a cam surface to contact the contact surface of the roller, wherein the output signal of the sensor varies according to the force applied to the contact surface by the cam surface.

35. The apparatus of claim 34, wherein the pin includes a cutout and the sensor is disposed within the cutout.

36. The apparatus of claim 34, wherein the output signal includes a value representative of a dimensional range of the workpiece.

37. The apparatus of claim 36, further comprising a workpiece select switch being switchable to cause the clamp to recognize at least two different workpieces.
